(19) United States
(12) Patent Application Publication
(10) Pub. No.: US 2024/0303093 A1
(43) Pub. Date: Sep. 12, 2024

(54) COLLECTION AND USE OF TELEMETRY DATA TO MONITOR AND COLLECT MULTI-INTERFACE WORKFLOW INTERACTION

(71) Applicant: Dell Products, L.P., Round Rock, TX (US)

(72) Inventors: Claudia Realegeno, Maple Valley, WA (US); Justine Akehurst, Shelton, WA (US)

(21) Appl. No.: 18/182,226

(22) Filed: Mar. 10, 2023

(51) Int. Cl. G06F 9/451; H04L 9/40

(52) U.S. Cl. CPC G06F 9/451; H04L 63/08; H04L 63/102

(57) ABSTRACT

Use of telemetry data to monitor and collect multi-interface workflow interaction is presented herein. A system authenticates, based on a subscriber identification representing a subscriber of a workflow monitoring service, use of the workflow monitoring service via the subscriber; and in response to the authenticating, the system tracks, via the workflow monitoring service using the subscriber identification and telemetry data corresponding to a backend service comprising communication links between a device of the workflow monitoring service and respective devices corresponding to a group of user interfaces, a workflow comprising respective steps being performed by the subscriber via the group of user interfaces, in which the telemetry data represents the workflow. The group of user interfaces can include a graphical user interface, a command-line user interface, and/or an application programming interface.

### TECHNICAL FIELD

The subject disclosure generally relates to embodiments for collection and use of telemetry data to monitor and collect multi-interface workflow interaction.

### BACKGROUND

Workflow information is valuable for designing an application per user needs, prioritizing critical improvements of the application, and/or providing well-informed support services for the application. Although conventional workflow technologies use browser cookies to track a user's interaction within a web-based graphical user interface (GUI), e.g., browser, such technologies cannot track the user's navigation between and/or within different browsers during a multi-browser-based workflow since different browsers use different cookies that cannot be tracked together within such workflow, and cookies of a browser are deleted when a browsing history of the browser is cleared.

Further, conventional workflow technologies cannot track the user's navigation during a multi-user interface (UI)-based workflow, e.g., between and/or within a browser and a command-line interface (CLI); between and/or within the browser and an application programming interface (API); between and/or within the CLI and the API. Moreover, conventional workflow technologies do not effectively provide sufficient detail regarding a CLI-based workflow as CLI information is recorded in compressed, plain text logs that are difficult to parse, do not include full workflow information, and are often unused until a problem with the CLI-based workflow occurs. Consequently, conventional workflow technologies have had some drawbacks, some of which may be noted with reference to the various embodiments described herein below.

### BRIEF DESCRIPTION OF THE DRAWINGS

Non-limiting embodiments of the subject disclosure are described with reference to the following Figures, in which like reference numerals refer to like parts throughout the various views unless otherwise specified:

FIG. 1 illustrates a block diagram of an enterprise cloud computing environment including a multi-interface workflow monitoring system that collects and uses telemetry data to monitor and collect multi-interface workflow interaction, in accordance with various example embodiments;

FIG. 2 illustrates a block diagram of a multi-interface workflow monitoring system that collects and uses telemetry data to monitor and collect multi-interface workflow interaction, in accordance with various example embodiments;

FIG. 3 illustrates a block diagram of a tracking component of a multi-interface workflow monitoring system that collects and uses telemetry data to monitor and collect multi-interface workflow interaction, in accordance with various example embodiments;

FIG. 4 illustrates a block diagram of a group of user interfaces of an enterprise cloud computing environment including a multi-interface workflow monitoring system that collects and uses telemetry data to monitor and collect multi-interface workflow interaction, in accordance with various example embodiments;

FIG. 5 illustrates a block diagram of a group of devices of an enterprise cloud computing environment including a multi-interface workflow monitoring system that collects and uses telemetry data to monitor and collect multi-interface workflow interaction, in accordance with various example embodiments;

FIG. 6 illustrates a block diagram of a multi-interface interaction of a workflow being performed within an enterprise cloud computing environment including a multi-interface workflow monitoring system that collects and uses telemetry data to monitor and collect multi-interface workflow interaction, in accordance with various example embodiments;

FIG. 7 illustrates a block diagram of an analysis component of a multi-interface workflow monitoring system that collects and uses telemetry data to monitor and collect multi-interface workflow interaction, in accordance with various example embodiments;

FIG. 8 illustrates a flow chart of a method associated with displaying respective UI actions that have been performed, via a group of user interfaces, by a subscriber of a UI workflow service, in accordance with various example embodiments;

FIG. 9 illustrates a flow chart of a method associated with sending, to a device of a UI workflow service via a data-based communication link, workflow information including timestamped UI actions that have been performed, via a UI of a group of user interfaces, by a subscriber of the UI workflow service, in accordance with various example embodiments;

FIG. 10 illustrates a flow chart of a method associated with displaying information representing respective steps of a workflow being performed within and across distinct user interfaces, in accordance with various example embodiments; and

FIG. 11 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional workflow technologies cannot track, via browser cookies, a user's navigation between and/or within different browsers during a multi-browser-based workflow; cannot track, via browser cookies, the user's navigation between and/or within a browser and a CLI, between the browser and an API, or between and/or within the CLI and the API during a multi-UI-based workflow; and cannot effectively provide sufficient detail regarding a CLI-based workflow using plain-text logs that are difficult to parse and are not investigated until an error occurs. In various embodiments described herein, a multi-interface workflow monitoring system uses telemetry data to monitor and collect multi-interface workflow interaction to facilitate analysis and optimization of a workflow across and/or within different user interfaces, e.g., including GUI(s), CLI(s), API(s), and/or other user interface(s).

For example, in embodiment(s), the multi-interface workflow monitoring system comprises an authentication component, a tracking component, and an analysis component. The authentication component authenticates, based on a subscriber identification (ID) representing a subscriber of a workflow monitoring service, that the subscriber has been authorized to use the workflow monitoring service.

In turn, the multi-interface workflow monitoring system tracks, via the workflow monitoring service using the subscriber ID and telemetry data corresponding to a backend service, e.g., a secure remote service (SRS) comprising communication links between respective devices corresponding to a group of user interfaces and a component of the multi-interface workflow monitoring system, a workflow comprising respective steps being performed by the subscriber via the group of user interfaces—the telemetry data representing the respective steps of the workflow that have been performed by the subscriber via the group of user interfaces, e.g., including GUI(s), CLI(s), API(s), and/or other user interfaces(s).

In one embodiment, the workflow corresponds to a modification of a group of nodes (e.g., data storage nodes, data elements) of a cluster (e.g., data storage cluster, data cluster) corresponding to the subscriber—the modification including a creation of a node, a modification of the node, or a removal of the node.

In another embodiment, in response to the subscriber being determined to have logged in, using the subscriber ID, to a UI of the group of user interfaces, the tracking component: stores, in a data store corresponding to the component of the multi-interface workflow monitoring system, information representing the subscriber ID and the UI; determines steps of the respective steps of the workflow that have been performed by the subscriber via the UI; and records, in the data store, the steps that have been performed by the subscriber via the UI.

In yet another embodiment, the tracking component determines respective timestamps representing respective times that the steps have been determined to have been performed; associates the respective timestamps with the steps to obtain timestamped workflow information; and sends, e.g., periodically based on a defined time period, the timestamped workflow information to the component of the multi-interface workflow monitoring system.

In an embodiment, the analysis component displays, based the telemetry data, via an interface corresponding to the component of the multi-interface workflow monitoring system, the respective steps of the workflow. In this regard, in one embodiment, the analysis component displays a first portion of the respective steps of the workflow that have been determined, based on the subscriber ID, to have been performed via a first UI (e.g., GUI, CLI, or API) of the group of user interfaces; and displays a second portion of the respective steps of the workflow that have been determined, based on the subscriber ID, to have been performed via a second UI (e.g., GUI, CLI, or API) of the group of user interfaces that is different from the first UI.

In one embodiment, the analysis component displays, based on the telemetry data, remaining respective portions of the respective steps of the workflow that have been determined, based on the subscriber ID, to have been performed via remaining user interfaces of the group of user interfaces, e.g., via a GUI, CLI, and/or API.

In another embodiment, in response to receiving an input representing that the subscriber has requested to revoke the use of the workflow monitoring service, the tracking component disables tracking of the workflow.

In yet another embodiment, in response to determining that inactivity of the workflow satisfies a defined condition representing that the workflow abruptly ended or timed out, the tracking component stores, in the data store corresponding to the component of the multi-interface workflow monitoring system, information representing that the workflow has abruptly ended or timed out. In embodiment(s), such information comprises a time that the inactivity of the workflow has been determined to have abruptly ended or timed out.

In one embodiment, the analysis component, e.g., utilizing machine learning, can facilitate optimization of a workflow across and/or within different user interfaces. In this regard, in an embodiment, the analysis component can determine, e.g., via machine learning, whether a step of a workflow corresponding to a UI of the group of user interfaces satisfies a defined condition representing that the step has been rarely performed among respective steps that have been performed among a group of workflows including the workflow and corresponding to the group of user interfaces, e.g., that the step has been performed less than a defined percentage (e.g., 1%) of an amount of the respective steps that have been performed among the group of workflows; and in response to the step being determined to have been rarely performed among the respective steps, the analysis component can recommend that the step be prevented from being included in the UI in a subsequent workflow that is subsequent to the workflow, e.g., to reduce screen clutter in a GUI, to streamline steps to be performed via the UI.

In other embodiment, the analysis component, e.g., utilizing machine learning, can determine whether a step of a workflow corresponding to a UI of the group of user interfaces satisfies a defined condition representing that the step has been frequently performed among a group of workflows including the workflow and corresponding to the group of user interfaces, e.g., that the step has been performed greater than a defined percentage (e.g., 60%) of an amount of the steps that have been performed among the group of workflows; and in response to the step being determined to have been frequently performed among the group of workflows, the analysis component can facilitate, via the UI, performance of the step in a subsequent workflow that is subsequent to the workflow.

For example, in an embodiment, the analysis component can provide, via the UI, a shortcut for the subscriber to complete (or select) the frequently performed step. In another embodiment, the analysis component can emphasize, via the UI, an element of the UI (e.g., widget), e.g., by enlarging the element in a GUI, highlighting the element in the GUI, and/or displaying the element in a different location (e.g., more prominent location) of the GUI.

In other embodiment(s), the analysis component, e.g., utilizing machine learning, can determine and/or identify workflow(s) of the group of workflows that the subscriber frequently performs, e.g., workflow(s) that have been performed by the subscriber more than a defined percentage, e.g., 60%, of respective numbers of times that workflows of the group of workflows have been performed by the subscriber; and in response to such determination, the analysis component can provide respective shortcuts for the subscriber to complete (or select) the workflow(s).

In yet another embodiment, the analysis component, e.g., utilizing machine learning, can determine and/or identify common subscriber workflow(s) of a group of workflows, and/or common step(s) of a group of steps, which have been frequently performed by different subscribers (of a group of subscribers including the subscriber) among/across the group of workflows, e.g., workflow(s) and/or steps(s) that have been performed by the different subscribers among the group of workflows more than a defined percentage, e.g., 60%, of respective numbers of times that workflows of the group of workflows, or steps of the group of steps, have been performed by the different subscribers; and in response to such determination, the analysis component can provide respective shortcuts for the subscriber to complete (or select) the workflow(s), or the step(s).

In an embodiment, the analysis component, e.g., utilizing machine learning, can determine and/or identify subscriber(s) who have selected, via the respective user interfaces, help resources more often than a defined percentage, e.g., 75%, of respective numbers of times that other subscribers have selected help resources via the respective interfaces; and in response to such determination, can enhance, e.g., via the UI, presentation and/or selection of support resources, support details, and/or guided assistance to facilitate access of the support resources, support details, and/or guided assistance within the UI.

In an embodiment, a method comprises: validating, by a system comprising a processor using an ID of a subscriber of a UI workflow service, that the subscriber has been authorized to utilize the UI workflow service; in response to the validating, determining, by the system utilizing the UI workflow service and the ID of the subscriber, UI navigation data representing a workflow comprising respective UI actions that have been performed by the subscriber via a group of user interfaces corresponding to respective devices; and sending, by the system utilizing the UI workflow service via respective data-based communication links between the respective devices and a component of the system, the UI navigation data from the respective devices to the component of the system.

In one embodiment, the method further comprises: in response to determining that the subscriber has logged in to a UI of the group of user interfaces, recording, by the system utilizing the UI workflow service, the ID of the subscriber and information representing the UI in a data store corresponding to the component of the system.

In another embodiment, the sending of the UI navigation data further comprises: determining a timestamp representing a time that a UI action of the respective UI actions has been performed by the subscriber via the UI; associating the timestamp with the UI action to obtain timestamped workflow information; and sending, via a data-based communication link, e.g., backhaul link, of the respective data-based communication links, the workflow information to the component of the system.

In yet another embodiment, the method further comprises: displaying, by the system, the respective UI actions that have been performed by the subscriber via the group of user interfaces.

In an embodiment, the displaying of the respective UI actions further comprises: displaying a first portion of the respective UI actions that have been determined, based on the ID of the subscriber, to have been performed via a first UI of the group of user interfaces; and displaying a second portion of the respective UI actions that have been determined, based on the ID of the subscriber, to have been performed via a second UI of the group of user interfaces that is different from the first UI.

In another embodiment, the displaying of the respective UI actions further comprises: displaying UI actions of the respective UI actions that have been determined, based on the ID of the subscriber, to have been performed via a UI of the group of user interfaces; and displaying portions of the respective UI actions that have been determined, based on the ID of the subscriber, to have been performed via respective user interfaces of the group of user interfaces that are different from the UI.

In one embodiment, a non-transitory machine-readable medium comprises instructions that, in response to execution, cause a system comprising a processor to perform operations, the operations comprising: determining that a subscriber identity representing a subscriber of a workflow monitoring service has been authorized to utilize the workflow monitoring service; detecting, via the workflow monitoring service, respective steps of a workflow being performed via the subscriber identity using a group of user interfaces comprising distinct user interfaces; and sending, via a backend communication channel between respective devices corresponding to the group of user interfaces and a device of the system, telemetry data representing the respective steps to the device of the system to facilitate an analysis of the respective steps of the workflow being performed across the distinct user interfaces.

In another embodiment, the operations further comprise: based on the telemetry data, displaying, via the workflow monitoring service, information representing the respective steps of the workflow being performed within and across the distinct user interfaces.

As described above, workflow details are highly valuable for optimizing a user's experience within a workflow. Conventionally, personnel devoted to user experience design, support, and product management lack valuable contextual understanding about how users interact with GUIs, CLIs, and APIs. Further, conventional workflow technologies cannot track a user's workflow with respect to navigation between different user interfaces, or with respect to access of different devices, e.g., storage nodes, using a UI.

In addition, conventional enterprise solutions do not provide a level of detail necessary to understand how users navigate via multi-interfaces within corresponding systems, e.g., including storage and/or server devices. This lack of contextual information negatively affects product support. For example, information about actions performed on a storage device and/or server device is recorded in compressed plain text logs that are difficult to parse. As a result, logged data often goes unused until and unless an issue occurs. In another example, conventional workflow technologies rely on browser cookies, which are only available in browser-based GUIs, are cleared when a browser's history is cleared, and are subject to permission settings at the browser level.

On the other hand, various embodiments disclosed herein corresponding to a multi-interface workflow monitoring system can: improve access to, and visibility of, a user's workflow across multiple interfaces including CLI(s) and API(s); enhance visibility and communication of the user's workflow to product, engineering, user experience, and/or support personnel; securely collect data via backend data communication channels compared with security vulnerable browser-based workflow technologies; increase user control over workflow data collection, and facilitate optimization of the user's workflow via machine learning.

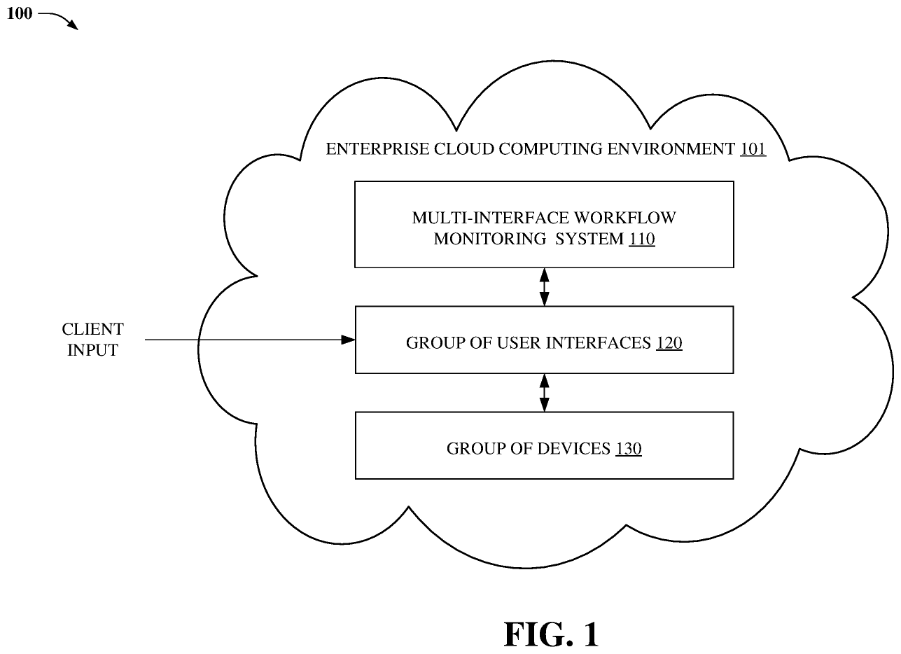

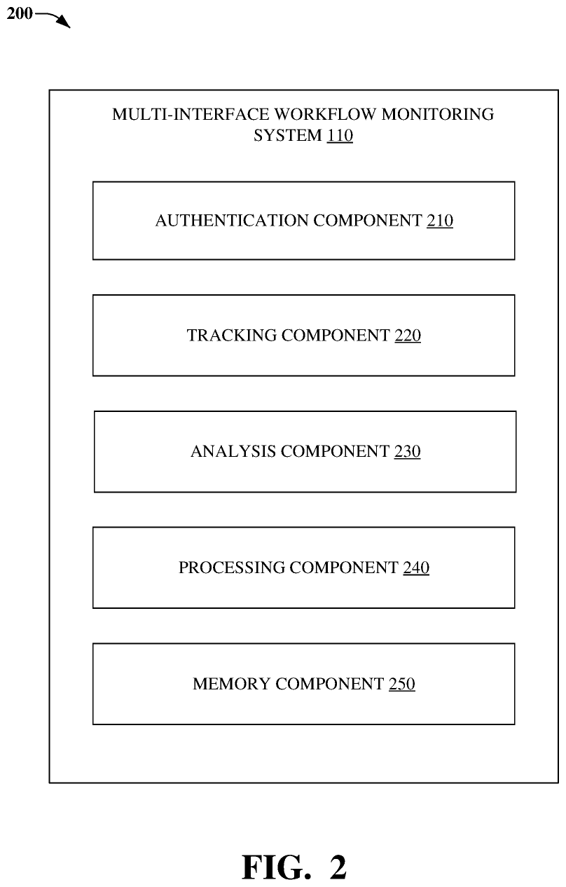

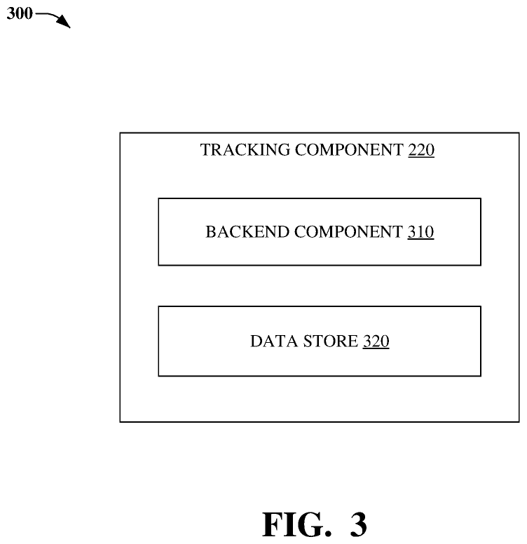

In this regard, and now referring to FIGS. 1-3, block diagrams (100-300) of an enterprise cloud computing environment (101) including a multi-interface workflow monitoring system (110) that uses telemetry data to monitor and collect multi-interface workflow interaction; the multi-interface workflow monitoring system; and a tracking component of the multi-interface workflow monitoring system are illustrated, respectfully, in accordance with various example embodiments.

The multi-interface workflow monitoring system includes an authentication component (210), a tracking component (220), an analysis component (230), a processing component (240), and a memory component (250). In embodiment(s), the memory component stores executable instructions that, when executed by the processing component, facilitate performance of operations by the multi-interface workflow monitoring system. For example, such operations include tracking a workflow being performed by a subscriber, or user, of a workflow monitoring service by tracking the subscriber's navigation within respective user interfaces (e.g., group of user interfaces 120) of the workflow using a subscriber ID of the subscriber, e.g., which has been used to log in to the respective user interfaces.

The authentication component determines, or authenticates, e.g., based on the subscriber ID being entered via the subscriber (e.g., as client input) during a log in procedure of a UI of the respective user interfaces, that the subscriber has been authorized to access the workflow monitoring service.

In an embodiment, the authentication component determines/authenticates that the subscriber has been authorized to access the workflow monitoring service by matching, via a data storage device (e.g., data store 320) of the tracking component, the subscriber ID with a list of authorized subscriber IDs that has been stored in the data storage device.

In response to the subscriber being determined to have logged in, using the subscriber ID, to the UI, and further in response to the subscriber being determined to be authorized to access the workflow monitoring service, the tracking component stores the subscriber ID and information referencing the UI in the data storage device.

In turn, in response to the subscriber being determined to be authorized to access the workflow monitoring service, a backend component (310) of the tracking component tracks, via the workflow monitoring service using the subscriber ID and telemetry data corresponding to a backend service (e.g., an SRS comprising communication links between respective devices (e.g., group of devices 130) corresponding to the respective user interfaces and a component of the multi-interface workflow monitoring system, respective steps of the workflow that have been performed by the subscriber via the UI—the telemetry data representing the respective steps.

In embodiment(s), the backend component tracks the respective steps by determining steps of the respective steps of the workflow that have been performed by the subscriber via the UI, and recording the steps in the data storage device.

In other embodiment(s), the backend component performs the recording of the steps by: determining respective timestamps representing respective times that the steps have been determined to have been performed; associating the respective timestamps with the steps to obtain timestamped workflow information; and sending, via the backend service, the timestamped workflow information—as the telemetry data—to the component of the multi-interface workflow monitoring system.

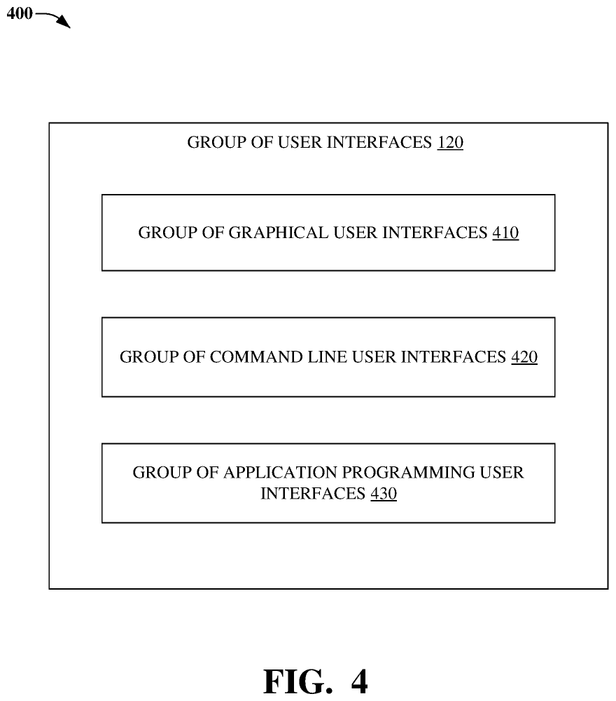

In embodiment(s) illustrated by FIG. 4., the respective user interfaces (e.g., group of user interfaces 120) includes a group of GUIs (410) including one or more GUIs, a group of CLIs (420) including one or more CLIs, and a group of application programming interfaces (APIs) (430) including one or more APIs.

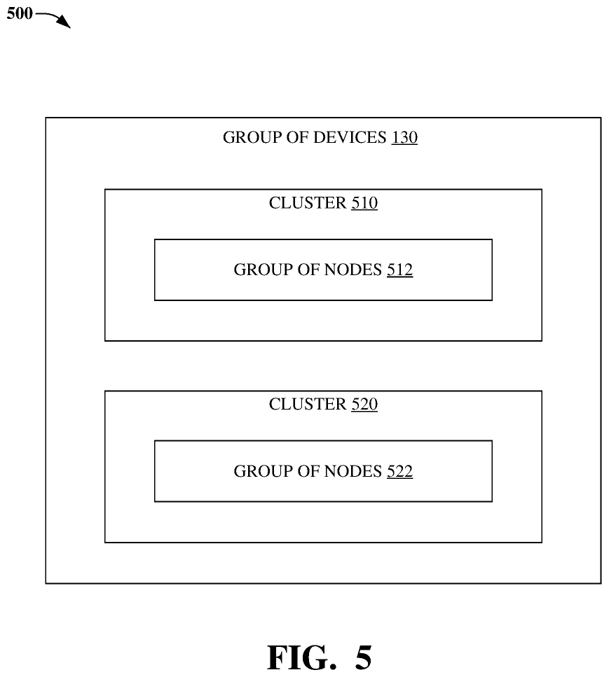

In other embodiment(s) illustrated by FIG. 5, the group of devices corresponding to the respective user interfaces includes clusters (510, 520) (e.g., a data storage cluster, a data cluster) comprising respective groups of nodes (512, 522) (e.g., data storage nodes, data elements). In embodiment(s), the group of devices are data storage devices, e.g., cloud-based storage devices of respective clusters, e.g., data storage clusters associated with a type of clustered file system that spreads data across multiple nodes, e.g., data storage nodes, of respective groups of nodes, e.g., groups of data storage nodes of the respective data storage clusters, e.g., usually for redundancy or performance.

The respective data storage nodes can be communicatively and/or operatively coupled to each other, and can communicate with user devices via wired and/or wireless communication network(s) to provide access to services (e.g., storage related services) that are based in the cloud and not stored locally (e.g., on a subscriber device). Further, a data storage node of the cluster can comprise a system, a server, a file system, an image of an operating system, data service(s), computer processing unit(s) (CPU(s)), storage devices (e.g., non-volatile memory devices, disk drives, solid-state drives), and/or memory devices (e.g., volatile memory devices, random access memory).

In this regard, in embodiment(s), the respective steps of the workflow performed by the subscriber via the group of user interfaces 120 correspond to operations, e.g., storage operations, being performed on the group of devices 130. For example, in an embodiment, the workflow corresponds to a modification of a data storage node of a group of data storage nodes of a data storage cluster corresponding to the subscriber. In one embodiment, the modification comprises creating the data storage node, modifying the data storage node, or removing the data storage node.

In embodiment(s), the backend component further associates, with the timestamped workflow information, device(s) of the respective devices corresponding to the steps that have been performed via the UI.

In other embodiment(s) corresponding to navigation within a GUI, the backend component determines that a step has begun in response to a determination that a page of the GUI has been rendered via a display and awaiting user input. The backend component determines that the step has ended in response to a determination that the user has performed, via the GUI, an action, and the GUI displays additional content such a new page or expanded information corresponding to a query for user input.

The following are examples in which the backend component has determined that the step has ended: the subscriber clicks on a link and the GUI loads a new page; the subscriber clicks on an arrow on a table and the GUI loads the next “page” of table content; the subscriber clicks on a carat and the GUI expands a previously collapsed section; and/or the subscriber clicks on a tooltip icon and additional information is displayed.

In yet other embodiment(s) corresponding to the GUI, a step can contain micro-interactions that are not considered by the analysis component to be registered/acknowledged as a step via the GUI, e.g., when the subscriber is typing into form field(s); scrolling; and/or clicking or pressing a “Tab” key to navigate between form fields. Further, micro-interactions that are not considered by the analysis component to be registered/acknowledged as a step via the GUI include when the GUI displays a the status of a process, e.g., a progression of an upgrade of an application.

In embodiment(s) corresponding to a CLI, the backend component determines that a step has begun in response to a determination that the subscriber has accessed, e.g., via the UI, the system, and/or in response to a determination that the subscriber has received a complete result from a prior interaction/step, and the system is awaiting to receive an input from the subscriber.

In other embodiment(s) corresponding to the CLI, the backend component determines that the step has ended in response to a determination that the subscriber enters and submits a command the CLI, e.g., prompting the CLI to return information or initiate or complete a process.

In yet other embodiment(s) corresponding to the CLI, a step can contain micro-interactions that are not considered by the analysis component to be registered/acknowledged as a step via the CLI, e.g., when the subscriber is entering a command and/or scrolling within the CLI.

In one embodiment, in response to receiving an input representing that the subscriber has requested to revoke the use of the workflow monitoring service, the tracking component disables tracking of the workflow.

In another embodiment, in response to determining that inactivity of the workflow satisfies a defined condition representing that the workflow abruptly ended or timed out, the tracking component stores, in the data store corresponding to the component of the multi-interface workflow monitoring system, information representing that the workflow has abruptly ended or timed out. In embodiment(s), such information comprises a time that the inactivity of the workflow has been determined to have abruptly ended or timed out.

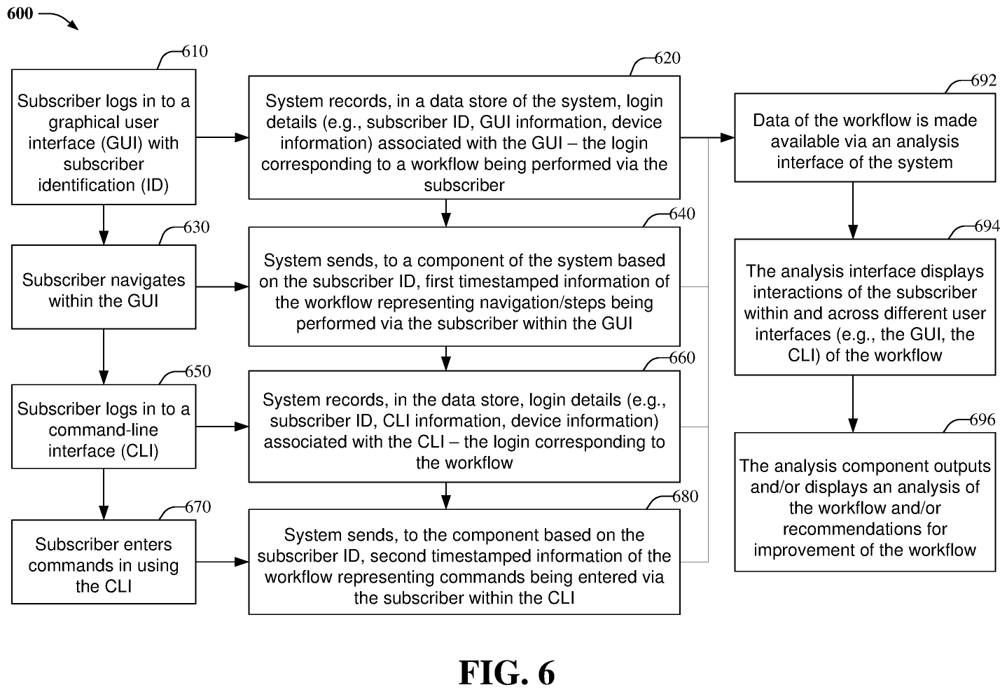

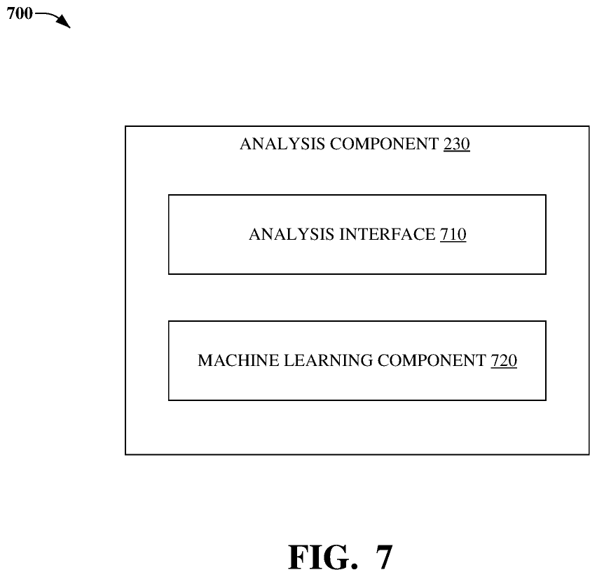

Referring now to FIGS. 6 and 7, block diagrams (600, 700) of a multi-interface interaction of a workflow being performed via a system (e.g., multi-interface workflow monitoring system) within an enterprise cloud computing environment (101); and an analysis component (230) of the system are illustrated, respectively, in accordance with various example embodiments. At 610, a subscriber of the workflow monitoring service logs in to a GUI using a subscriber ID. At 620, in response to the subscriber being authenticated, the system records, in a data store of the system, login details, e.g., subscriber ID, GUI information, device information, which are associated with the GUI—the login to the GUI corresponding to the workflow being performed via the subscriber.

At 630, the subscriber navigates within the GUI, e.g., performing steps of the workflow utilizing the GUI. At 640, the system sends (e.g., periodically based on a defined period) to a component of the system, based on the subscriber ID, first timestamped information of the workflow representing the steps that have been performed via the subscriber within the GUI.

At 650, the subscriber logs in to a CLI using the subscriber ID. At 660, in response to the subscriber being authenticated, the system records, in the data store of the system, login details, e.g., subscriber ID, CLI information, device information, which are associated with the CLI—the login to the CLI corresponding to the workflow being performed via the subscriber.

At 670, the subscriber navigates within the CLI, e.g., entering commands utilizing the CLI. At 680, the system sends, e.g., based on the defined period, to the component of the system based on the subscriber ID, second timestamped information of the workflow representing the commands being entered via the subscriber within the CLI.

At 692, data, e.g., the first timestamped information and the second timestamped information, is made available via an analysis interface (710) of the analysis component. As illustrated by FIG. 7, the analysis component includes the analysis interface and a machine learning component (720). At 694, the analysis component displays, e.g., using a display device (not shown) of the analysis interface based on the telemetry data, interactions of the subscriber within and across different user interfaces (e.g., the GUI, the CLI) of the workflow.

In this regard, in one embodiment, the analysis component displays a first portion of the respective steps of the workflow that have been determined, based on the subscriber ID, to have been performed via a first UI (e.g., GUI, CLI) of the respective user interfaces; and displays a second portion of the respective steps of the workflow that have been determined, based on the subscriber ID, to have been performed via a second UI (e.g., GUI, CLI) of the respective user interfaces that is different from the first UI.

At 696, the analysis component outputs and/or displays an analysis of the workflow and/or recommendations for improvement of the workflow. For example, in embodiment(s), the machine learning component can utilize machine learning to facilitate optimization of the workflow across and/or within different user interfaces. In this regard, in one embodiment, the machine learning component can determine, based on defined classifiers via machine learning model(s) corresponding to respective machine learning processes, whether a step of the respective steps of the workflow corresponding to a UI of the respective user interfaces satisfies a defined condition representative that, e.g., the step corresponds to a number of errors that have occurred in the workflow being greater than a threshold number of errors that have occurred during respective performances of a group of workflows including the workflow; the step has rarely been used/performed in the group of workflows—compared to other steps of the group of workflows; the step has frequently been used/performed in the group of workflows—compared to other steps of the group of workflows.

For example, in another embodiment, in response to the step being determined to have been rarely used in the group of workflows compared to the other steps of the group of workflows, the machine learning component can recommend, via the analysis interface, that the step be prevented from being performed via the UI, and/or from being included in the UI, e.g., in a subsequent workflow that is subsequent to the workflow.

In this regard, the defined classifiers can be stored in the data store and can represent respective defined conditions associated with analysis and/or improvement of the workflow, e.g., representative of a group of steps that have been performed by a subscriber before receiving an input from the subscriber requesting assistance with an issue; representative that a specific option that has been displayed on a page of a GUI has been rarely selected from the page by respective subscribers of corresponding workflows in which the specific option has been displayed, e.g., in which the machine learning component can recommend that the specific option be moved to another page corresponding to “advanced options”, e.g., to reduce visual noise corresponding to a display of the page.

In an embodiment, the analysis component, e.g., utilizing the machine learning component, can aggregate workflow information of workflows that have been performed by respective subscribers, e.g., aggregating respective steps that have been performed by the respective subscribers via the workflows, e.g., listing the respective steps in order from most used steps to least used steps that have been performed via the workflows.

In one embodiment, the analysis component can display, via the analysis interface using the telemetry data that has been stored in the data storage device, respective paths that the subscriber has navigated within respective user interfaces of a workflow, e.g., within GUI(s) of the workflow; within CLI(s) of the workflow. In another embodiment, the analysis component can display, via the analysis interface, respective steps performed by the subscriber within a CLI, and/or display respective steps performed by the subscriber with respect to switching between respective uses of different storage nodes.

In another embodiment, the analysis component can display, using the telemetry data via the analysis interface, respective steps that been performed by the subscriber and/or across different subscribers corresponding to a defined outcome of interest. For example, the defined outcome of interest can include: an error that has occurred; an access of help resources; a completion of a feedback response; non-completion, e.g., canceling and/or exiting, of a multi-step workflow; a movement, based on the subscriber ID, between different user interfaces, e.g. between a CLI and a GUI; or an upgrade or rollback of a version of a corresponding user interface.

In yet another embodiment, the analysis component can display, using the telemetry data via the analysis interface, page metrics representing, e.g., pages of respective GUIs corresponding to an occurrence of the outcome of interest; respective frequencies of access of pages of the respective GUIs; or respective parameters of a GUI that are available to be selected or changed, but have not been selected or changed, e.g., corresponding to radio buttons, optional form fills, check boxes, submenu options, instances of opening a menu and closing the menu without detecting a selection of an option from the menu, or a frequency that collapsed sections of the GUI have been determined to have been opened.

It should be appreciated that various embodiments described herein with respect to operations performed via the analysis component can be performed with and/or without the machine learning component.

In embodiment(s), classifier(s), e.g., the defined classifiers, are explicitly trained, e.g., via generic training data, as well as implicitly trained, e.g., based on telemetry data. For example, support vector machines can be configured via a learning or training phase within a classifier constructor and feature selection module, or other component (all not shown) of the machine learning component. Thus, the classifier(s) can be used by the machine learning component to automatically learn and perform a number of functions, e.g., performed by a system (e.g., 110), including but not limited to determining whether a step of respective steps of a workflow corresponding to a UI of respective user interfaces satisfies a defined condition.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that is desired to be automatically performed, e.g., with respect to optimization of a workflow across and/or within different user interfaces. In embodiment(s), attributes represented by the input attribute vector can be information derived from a workflow, e.g., representing steps of the workflow that have been performed.

A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to, training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can include user (or subscriber) data, device data, application data, implicit data, and/or explicit data. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes, machine learning models, and/or systems (e.g., a decision tree based learning model, a linear regression based learning model, support vector machines, neural networks, expert systems, Bayesian belief networks, fuzzy logic, and data fusion engines) can be employed in connection with performing automatic and/or inferred action in connection with the disclosed subject matter.

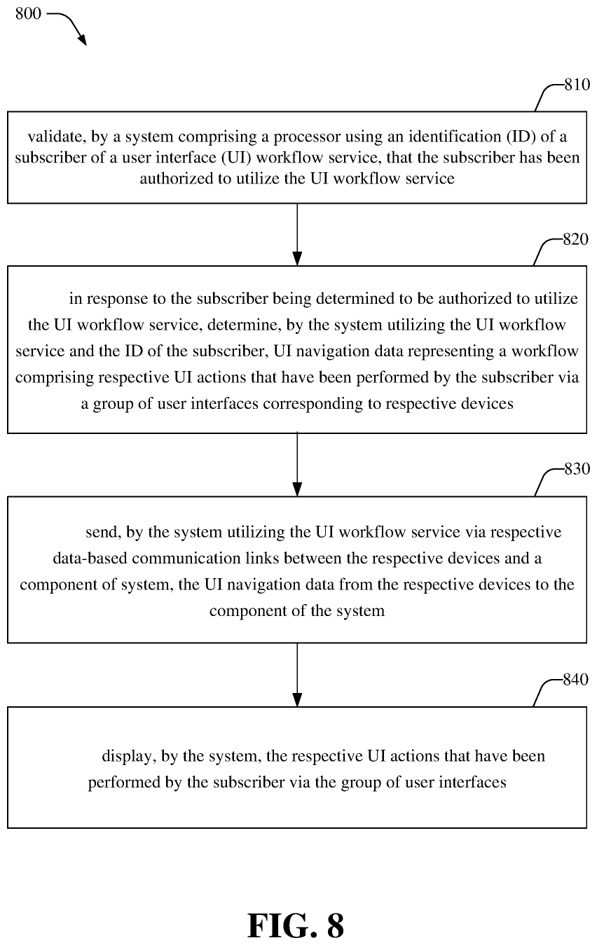

FIGS. 8-10 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 8 illustrates a flow chart (800) of a method associated with displaying respective UI actions that have been performed, via a group of user interfaces, by a subscriber of a UI workflow service, in accordance with various example embodiments. At 810, a system (e.g., 110) comprising a processor validates, using an ID of a subscriber of a UI workflow service, that the subscriber has been authorized to utilize the UI workflow service. At 820, in response to the subscriber being determined to be authorized to utilize the UI workflow service, the system determines, utilizing the UI workflow service and the ID of the subscriber, UI navigation data representing a workflow comprising respective UI actions that have been performed by the subscriber via a group of user interfaces corresponding to respective devices, e.g., data storage devices, data storage nodes, or other storage devices.

At 830, the system sends, utilizing the UI workflow service via respective data-based communication links between the respective devices and a component of system, the UI navigation data from the respective devices to the component of the system. At 840, the system displays the respective UI actions that have been performed by the subscriber via the group of user interfaces.

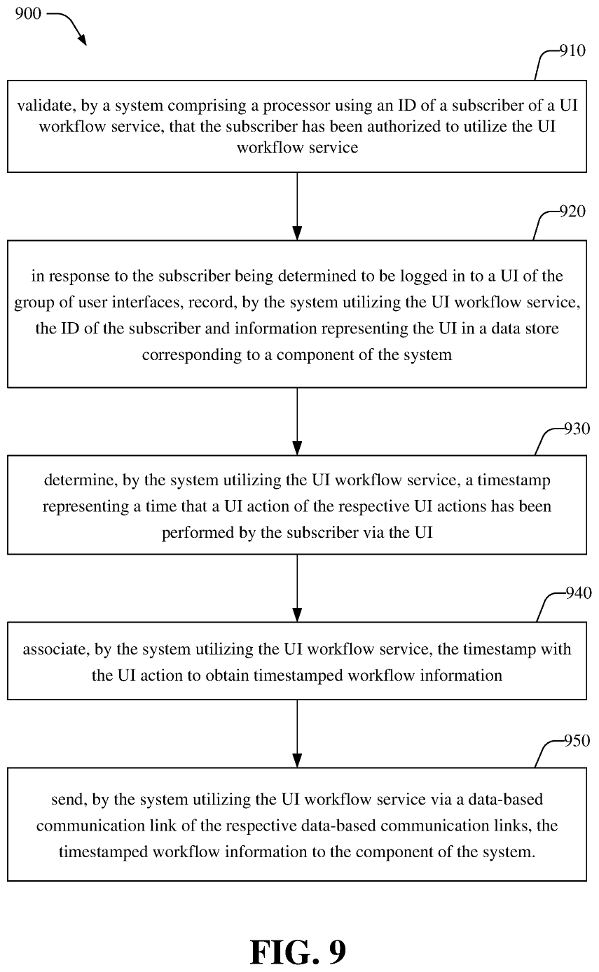

FIG. 9 illustrates a flow chart (900) of a method associated with sending, to a device of a UI workflow service via a data-based communication link, workflow information including timestamped UI actions that have been performed, via a UI of a group of user interfaces, by a subscriber of the UI workflow service, in accordance with various example embodiments. At 910, a system (e.g., 110) comprising a processor validates, using an ID of a subscriber of a UI workflow service, that the subscriber has been authorized to utilize the UI workflow service. At 920, in response to the subscriber being determined to be logged in to a UI of the group of user interfaces, the system records, utilizing the UI workflow service, the ID of the subscriber and information representing the UI in a data store corresponding to a component of the system.

At 930, the system determines, utilizing the UI workflow service, a timestamp representing a time that a UI action of the respective UI actions has been performed by the subscriber via the UI. At 940, the system associates, utilizing the UI workflow service, the timestamp with the UI action to obtain timestamped workflow information. At 950, the system sends, utilizing the UI workflow service via a data-based communication link of the respective data-based communication links, the timestamped workflow information to the component of the system.

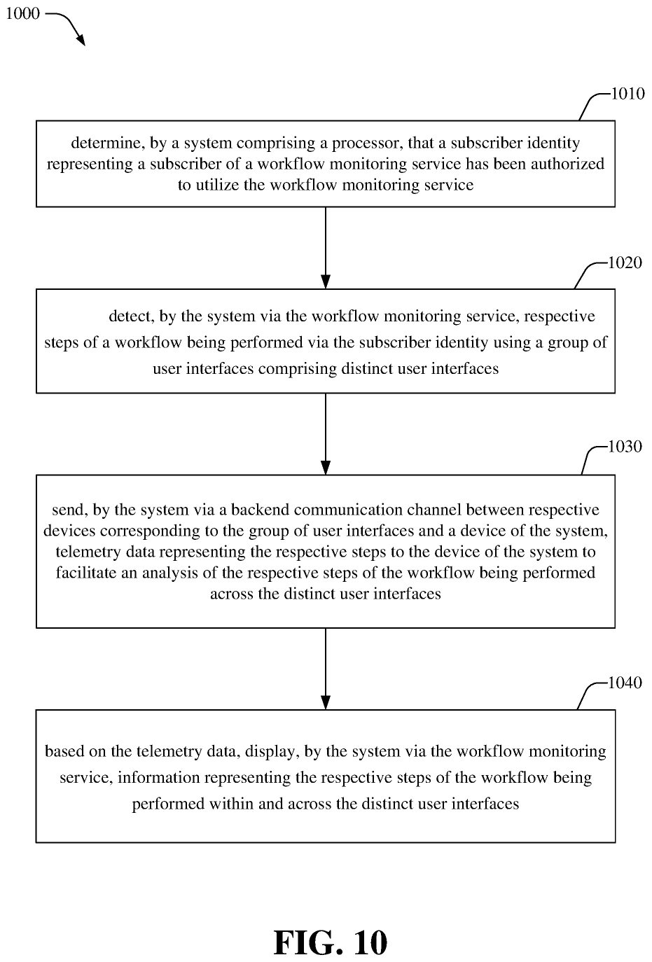

FIG. 10 illustrates a flow chart (1000) of a method associated with displaying information representing respective steps of a workflow being performed within and across distinct user interfaces, in accordance with various example embodiments. At 1010, a system (e.g., 110) comprising a processor determines that a subscriber identity representing a subscriber of a workflow monitoring service has been authorized to utilize the workflow monitoring service. At 1020, the system detects, via the workflow monitoring service, respective steps of a workflow being performed via the subscriber identity using a group of user interfaces comprising distinct user interfaces.

At 1030, the system sends, via a backend communication channel between respective devices corresponding to the group of user interfaces and a device of the system, telemetry data representing the respective steps to the device of the system to facilitate an analysis of the respective steps of the workflow being performed across the distinct user interfaces. At 1040, based on the telemetry data, the system displays, via the workflow monitoring service, information representing the respective steps of the workflow being performed within and across the distinct user interfaces.

Reference throughout this specification to “one embodiment,”“an embodiment,”“another embodiment”, or “yet another embodiment” means that a particular feature, structure, or characteristic described in connection with the embodiment is included in at least one embodiment. Thus, the appearances of the phrase “in one embodiment,”“in an embodiment,”“in another embodiment”, or “in yet another embodiment” in various places throughout this specification are not necessarily all referring to the same embodiment. Furthermore, the particular features, structures, or characteristics may be combined in any suitable manner in one or more embodiments.

Furthermore, to the extent that the terms “includes,”“has,”“contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic”, “logical”, “logically”, and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component”, “system”, and the like are intended to refer to a computer-related entity, hardware, software (e.g., in execution), middleware, and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

As it is employed in the subject specification, the term “processing component” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “data storage”, “data store”, “storage space”, “data storage device”, “storage medium”, “memory component”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in memory component (250), non-volatile memory 1122 (see below), disk storage 1124 (see below), and/or memory storage 1146 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1120) can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

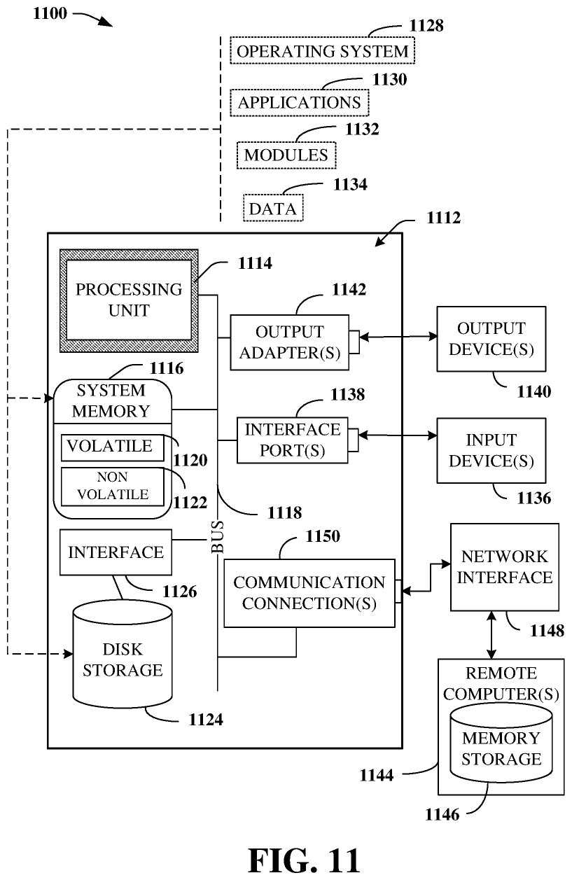

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 11, a block diagram of a computing system 1100 operable to execute the disclosed systems and methods, e.g., via enterprise cloud computing environment (101), is illustrated, in accordance with an embodiment. Computer 1112 comprises a processing unit 1114, a system memory 1116, and a system bus 1118. System bus 1118 couples system components comprising, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1116 comprises volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can comprise ROM, PROM, EPROM, EEPROM, or flash memory. Volatile memory 1120 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also comprises removable/non-removable, volatile/non-volatile computer storage media. FIG. 11 illustrates, for example, disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users, e.g., subscribers, and computer resources described in suitable operating environment 1100. Such software comprises an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user, e.g., subscriber, can enter commands or information into computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1114 through system bus 1118 via interface port(s) 1138. Interface port(s) 1138 comprise, for example, a serial port, a parallel port, a game port, a universal serial bus (USB), a wireless based port, e.g., Wi-Fi, Bluetooth, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140, like display devices, light projection devices, monitors, speakers, and printers, among other output devices 1140, which use special adapters. Output adapters 1142 comprise, by way of illustration and not limitation, video and sound devices, cards, etc. that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically comprises many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically and/or wirelessly connected via communication connection 1150. Network interface 1148 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can comprise, for example, internal and external technologies such as modems, comprising regular telephone grade modems, cable modems and DSL modems, wireless modems, ISDN adapters, and Ethernet cards.

The computer 1112 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1112 can connect to other devices/networks by way of antenna, port, network interface adaptor, wireless access point, modem, and/or the like.

The computer 1112 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable components that, when executed by the processor, facilitate performance of operations by the system, the operations comprising:
based on a subscriber identification (ID) representing a subscriber of a workflow monitoring service, authenticating use of the workflow monitoring service via the subscriber; and
in response to the authenticating of the use of the workflow monitoring service, tracking, via the workflow monitoring service using the subscriber ID and telemetry data corresponding to a backend service comprising communication links between respective devices corresponding to a group of user interfaces and a component of the system, a workflow comprising respective steps being performed by the subscriber via the group of user interfaces, wherein the telemetry data represents the workflow.

2. The system of claim 1, wherein the group of user interfaces comprises at least one of a graphical user interface, a command-line user interface, or an application programming interface.

3. The system of claim 1, wherein the workflow corresponds to a modification of a group of data storage nodes of a data storage cluster corresponding to the subscriber, and wherein the modification comprises a creation of the data storage node, a modification of the data storage node, or a removal of the data storage node.

4. The system of claim 1, wherein the tracking further comprises:
in response to the subscriber being determined to have logged in, using the subscriber ID, to a user interface (UI) of the group of user interfaces,
storing, in a data store corresponding to the component of the system, information representing the subscriber ID and the UI,
determining steps of the respective steps of the workflow that have been performed by the subscriber via the UI, and
recording, in the data store, the steps that have been performed by the subscriber via the UI.

5. The system of claim 4, wherein the recording of the steps further comprises:
determining respective timestamps representing respective times that the steps have been determined to have been performed;
associating the respective timestamps with the steps to obtain timestamped workflow information; and
sending the timestamped workflow information to the component of the system.

6. The system of claim 1, wherein the operations further comprise:
based the telemetry data, displaying, via an interface corresponding to the component of the system, the respective steps of the workflow.

7. The system of claim 6, wherein the displaying of the respective steps further comprises:
displaying a first portion of the respective steps of the workflow that have been determined, based on the subscriber ID, to have been performed via a first user interface (UI) of the group of user interfaces; and
displaying a second portion of the respective steps of the workflow that have been determined, based on the subscriber ID, to have been performed via a second UI of the group of user interfaces that is different from the first UI.

8. The system of claim 7, wherein the first UI is a first graphical user interface (GUI), a first command-line interface (CLI), or a first application programming interface (API), and wherein the second UI is a second GUI, a second CLI, or a second API.

9. The system of claim 1, wherein the operations further comprise:
in response to receiving an input representing that the subscriber has requested to revoke the use of the workflow monitoring service, disabling the tracking.

10. The system of claim 1, wherein the operations further comprise:
in response to determining that inactivity of the workflow satisfies a defined condition representing that the workflow abruptly ended or timed out, storing, in a data store corresponding to the component of the system, information representing that the workflow has abruptly ended or timed out, wherein the information comprises a time that the inactivity of the workflow has been determined to satisfy the defined condition representing that the workflow has abruptly ended or timed out.

11. The system of claim 1, wherein the backend service comprises a secure remote service that facilitates, based on the telemetry data, an analysis of the workflow.

12. The system of claim 11, wherein the workflow is a first workflow, and wherein the operations further comprise:
determining, via the analysis, whether a step of the respective steps of the first workflow corresponding to a user interface (UI) of the group of user interfaces satisfies a defined condition representing that the step has been rarely performed among a group of workflows comprising the workflow compared to remaining steps of the respective steps of the group of workflows; and
in response to the step being determined to have been rarely performed among the group of workflows compared to the remaining steps of the group of workflows, preventing the step from being performed, via the UI, in a subsequent workflow that is subsequent to the workflow.

13. The system of claim 11, wherein the workflow is a first workflow, and wherein the operations further comprise:
determining, via the analysis, whether a step of the respective steps of the first workflow corresponding to a user interface (UI) of the group of user interfaces satisfies a defined condition representing that the step has been frequently performed among a group of workflows comprising the workflow compared to remaining steps of the respective steps of the group of workflows; and
in response to the step being determined to have been frequently performed among the group of workflows compared to the remaining steps of the group of workflows, facilitating, via the UI, performance of the step in a subsequent workflow that is subsequent to the workflow.

14. A method, comprising:
validating, by a system comprising a processor using an identification (ID) of a subscriber of a user interface (UI) workflow service, that the subscriber has been authorized to utilize the UI workflow service;
in response to the validating, determining, by the system utilizing the UI workflow service and the ID of the subscriber, UI navigation data representing a workflow comprising respective UI actions that have been performed by the subscriber via a group of user interfaces corresponding to respective devices; and
sending, by the system utilizing the UI workflow service via respective data-based communication links between the respective devices and a component of the system, the UI navigation data from the respective devices to the component of the system.

15. The method of claim 14, further comprising:
in response to determining that the subscriber has logged in to a UI of the group of user interfaces, recording, by the system utilizing the UI workflow service, the ID of the subscriber and information representing the UI in a data store corresponding to the component of the system.

16. The method of claim 15, wherein the sending of the UI navigation data further comprises:
determining a timestamp representing a time that a UI action of the respective UI actions has been performed by the subscriber via the UI;
associating the timestamp with the UI action to obtain timestamped workflow information; and
sending, via a data-based communication link of the respective data-based communication links, the workflow information to the component of the system.

17. The method of claim 14, further comprising:
displaying, by the system, the respective UI actions that have been performed by the subscriber via the group of user interfaces.

18. The method of claim 17, wherein the displaying of the respective UI actions further comprises:
displaying UI actions of the respective UI actions that have been determined, based on the ID of the subscriber, to have been performed via a UI of the group of user interfaces; and
displaying portions of the respective UI actions that have been determined, based on the ID of the subscriber, to have been performed via respective user interfaces of the group of user interfaces that are different from the UI.

19. A non-transitory machine-readable medium comprising instructions that, in response to execution, cause a system comprising a processor to perform operations, the operations comprising:
determining that a subscriber identity representing a subscriber of a workflow monitoring service has been authorized to utilize the workflow monitoring service;
detecting, via the workflow monitoring service, respective steps of a workflow being performed via the subscriber identity using a group of user interfaces comprising distinct user interfaces; and
sending, via a backend communication channel between respective devices corresponding to the group of user interfaces and a device of the system, telemetry data representing the respective steps to the device of the system to facilitate an analysis of the respective steps of the workflow being performed across the distinct user interfaces.

20. The non-transitory machine-readable medium of claim 19, wherein the operations further comprise:
based on the telemetry data, displaying, via the workflow monitoring service, information representing the respective steps of the workflow being performed within and across the distinct user interfaces.
